(19) United States
(12) Patent Application Publication
(10) Pub. No.: US 2016/0268588 A1
(43) Pub. Date: Sep. 15, 2016

(54) ALKALINE DRY CELL

(71) Applicant: PANASONIC INTELLECTUAL PROPERTY MANAGEMENT CO., LTD., Osaka-shi, Osaka (JP)

(72) Inventor: Tadaya OKADA, Osaka (JP)

(73) Assignee: PANASONIC INTELLECTUAL PROPERTY MANAGEMENT CO. LTD., Osaka (JP)

(21) Appl. No.: 15/034,152

(22) PCT Filed: Sep. 17, 2014
(86) PCT No.: PCT/JP2014/004786

§ 371 Date: May 3, 2016

(30) Foreign Application Priority Data
Nov. 15, 2013 (JP) 2013-236428

(51) Int. Cl. H01M 4/06; H01M 4/10; H01M 2/30; H01M 4/62; H01M 4/42; H01M 2/16; H01M 6/08; H01M 4/50

(52) U.S. Cl. CPC H01M 4/06; H01M 6/085; H01M 4/10; H01M 4/50; H01M 4/625; H01M 4/42; H01M 2/1626; H01M 2/162; H01M 2/30; H01M 2004/028

(57) ABSTRACT

An alkaline dry cell of the present invention includes: a positive electrode case having a nickel plating layer on its surface; a positive electrode provided in the positive electrode case; and a negative electrode provided in a hollow portion of the positive electrode with a separator interposed between the positive and negative electrodes. The positive electrode case has a nickel-cobalt alloy plating layer and a carbon material layer which extend over the nickel plating layer on an inner surface of the positive electrode case, and the carbon material layer is formed after annealing of the alloy plating layer. The alloy plating layer has a thickness ranging from 0.05 μm to 0.4 μm, and a mass ratio of cobalt relative to a total amount of nickel and cobalt contained in the alloy plating layer ranges from 37% to 57%.

### TECHNICAL FIELD

The present invention relates to an alkaline dry cell, and more specifically, to a positive electrode case of the alkaline dry cell.

### BACKGROUND ART

Alkaline dry cells are widely used as power sources of various devices. Due to anxiety about recent abnormal weather and increasing awareness of disaster prevention, the alkaline dry cells are also used as emergency power sources. Therefore, it is required for alkaline dry cells to improve in the leak-proof characteristics and storage characteristics (i.e. discharge performance after storage) such that leakages and self-consumption will be avoided even if the cells are stored for a long period of time without being used.

Each alkaline dry cell includes a positive electrode case where the power-generating elements are housed. The positive electrode case of the alkaline dry cell is formed using a nickel-plated steel plate. The surface of the positive electrode case is provided with a nickel plating layer to prevent corrosion of its base material, which is iron. The nickel plating layer, however, undergoes oxidation by the positive electrode active material during a period of storage, and consequently, an oxide film of a nickel oxide is formed on the surface. This oxide film has high electric resistance and degrades the electrical contact between the positive electrode case and the positive electrode, thereby causing deterioration of the discharge performance of the alkaline dry cell after storage.

Patent Document 1 proposes a method of forming a positive electrode case. The method includes: providing a cold-rolled steel plate which has nickel plating layers previously formed on its both faces; forming a nickel-cobalt alloy plating layer on one of the faces of the cold-rolled steel plate; and performing drawing and ironing processing on the cold-rolled steel plate such that the face coated with the nickel-cobalt alloy plating layer constitutes the inner face of the resultant positive electrode case. Patent Document 1 describes that causing cracks in the hard nickel-cobalt alloy plating layer during the formation the case results in an increase in the contact area with a positive electrode mixture, which allows for reducing the cell inner resistance and preventing a deterioration of the heavy load characteristics after storage.

Patent Document 2 describes a positive electrode case which has a nickel plating layer on its inner face, and a nickel-cobalt alloy layer on the nickel plating layer. Patent Document 2 proposes that the nickel-cobalt alloy layer have a thickness equal to or greater than 0.15 μm and equal to or smaller than 0.25 μm, and the ratio of cobalt relative to the alloy be equal to or greater than 40% and equal to or smaller than 60%. Patent Document 2 further describes that the inner face of the positive electrode case preferably has a roughness ranging from 1.0 μm to 1.5 μm in terms of Ra. Patent Document 2 describes that these features allow the positive electrode case, in spite of the absence of a carbon material layer on its inner face, to prevent an increase in the contact resistance with a positive electrode mixture and to have discharge performance which is the same or similar to that of conventional cells.

Patent Document 2 also discloses that cobalt eluted from the nickel-cobalt alloy layer is deposited on the zinc of the negative electrode, and a leakage may be caused by a gas generated by corrosion of the zinc (see paragraphs [0027] to [0030]). In this respect, Patent Document 2 deduces, through an experiment in which the base for use in the positive electrode case (the base before being formed into positive electrode case) was immersed in an alkaline electrolyte, a range of the ratio of cobalt (60% or less) within which the elution of cobalt from the nickel-cobalt alloy layer is prevented.

### CITATION LIST

### Patent Document

Patent Document 1: Japanese Unexamined Patent Publication No. 2003-17010

Patent Document 2: Japanese Unexamined Patent Publication No. 2012-48958

### SUMMARY OF THE INVENTION

### Technical Problem

According to Patent Document 1, the cracks are caused during the formation of the positive electrode case, which leads to good electric contact with the positive electrode and consequently provides high discharge performance after storage. However, the increase in the surface area due to the cracks in the nickel-cobalt alloy plating layer promotes the elution of cobalt, and causes deterioration of the leak-proof characteristics.

Regarding Patent Document 2, in view of the deduced range in which the elution of cobalt from the nickel-cobalt alloy plating layer is prevented, the leak-proof characteristics would be deteriorated for the following two reasons.

The first reason is that the surface state of the base before being formed into the positive electrode case is usually different from the surface state after being formed into the positive electrode case. The case-forming processing unavoidably causes not a few cracks. If the nickel-cobalt alloy plating layer has high hardness, an increased number of cracks will be caused in its surface, as compared to the base.

The second reason is that the degree at which cobalt is eluted in a situation where the base is simply immersed in an alkaline electrolyte is largely different from the degree at which cobalt is eluted in a situation where the base forms part of a cell and a potential of the positive electrode is applied to the base. Naturally, more cobalt is eluted in the latter situation than in the former situation.

Further, the positive electrode case of Patent Document 2 includes no carbon material layer for covering its inner face. Therefore, the positive electrode case is not capable of preventing the cobalt elution sufficiently in the cell, and the cell is not expected to have good leak-proof characteristics.

In view of the foregoing, it is therefore an object of the present invention to provide an alkaline dry cell which has good leak-proof characteristics and provides high discharge performance after storage.

### Solution to the Problem

To achieve the object, an alkaline dry cell of the present invention includes: a positive electrode case made of a nickel-plated steel plate having a nickel plating layer on a surface thereof; a positive electrode having a hollow cylindrical shape and provided in the positive electrode case; and a negative electrode provided in a hollow portion of the positive electrode with a separator interposed between the positive and negative electrodes. The positive electrode case has a nickel-cobalt alloy plating layer and a carbon material layer which extend over the nickel plating layer on an inner surface of the positive electrode case, and the carbon material layer is formed after annealing of the nickel-cobalt alloy plating layer on the nickel plating layer. The nickel-cobalt alloy plating layer has a thickness ranging from 0.05 μm to 0.4 μm, and a mass ratio of cobalt relative to a total amount of nickel and cobalt contained in the nickel-cobalt alloy plating layer ranges from 37% to 57%.

### Advantages of the Invention

The present invention reduces cracks caused in the nickel-cobalt alloy plating layer during formation of the positive electrode case, thereby reducing an increase in the surface area. Further, the carbon material layer coating the inner surface reduces the elution of cobalt. The nickel-cobalt alloy plating layer allows for maintaining suitable electrical contact between the positive electrode case and the positive electrode. Thus, the cell of the present invention offers advantages of good leak-proof characteristics and high discharge performance after storage.

### BRIEF DESCRIPTION OF THE DRAWINGS

FIG. 1 shows a half section of an alkaline dry cell according to an embodiment of the present invention.

FIG. 2 schematically shows a positive electrode case in an enlarged scale.

FIG. 3 is a graph on which amounts of generated gas measured after storage are plotted, in relation to the thickness of a nickel-cobalt alloy plating layer and the mass ratio of cobalt relative to the total amount of nickel and cobalt.

### DESCRIPTION OF EMBODIMENTS

According to the present invention, an alkaline dry cell includes: an alkaline dry cell of the present invention includes: a positive electrode case made of a nickel-plated steel plate having a nickel plating layer on a surface thereof; a positive electrode having a hollow cylindrical shape and provided in the positive electrode case; and a negative electrode provided in a hollow portion of the positive electrode with a separator interposed between the positive and negative electrodes. The positive electrode case has a nickel-cobalt alloy plating layer and a carbon material layer which extend over the nickel plating layer on an inner surface of the positive electrode case, and the carbon material layer is formed after annealing of the nickel-cobalt alloy plating layer on the nickel plating layer. The nickel-cobalt alloy plating layer has a thickness ranging from 0.05 μm to 0.4 μm, and a mass ratio of cobalt relative to a total amount of nickel and cobalt of contained in the nickel-cobalt alloy plating layer ranges from 37% to 57%. These features allow the alkaline dry cell of the present invention to have good leak-proof characteristics and high discharge performance after storage.

Reduction of cracks caused in the plated surface is achieved by making the nickel-cobalt alloy plating layer have a thickness of 0.4 μm or less, setting the mass ratio of cobalt relative to the total amount of nickel and cobalt contained in the nickel-cobalt alloy plating layer to be 57% or less, and annealing the nickel-cobalt alloy plating layer. Reducing the thickness of the nickel-cobalt alloy plating layer alleviates physical damage caused during the formation of the positive electrode case. Annealing the nickel-cobalt alloy plating layer reduces distortion occurring when the nickel-cobalt alloy plating layer is deformed. As a result, the cracks appearing in the plated surface during the formation of the positive electrode case is reduced.

The annealing is performed such that the nickel-plated steel plate having the nickel-cobalt alloy plating layer formed on the surface is heat treated to cause thermal diffusion. For example, to continuously annealing a steel plate in a hoop shape, the annealing is suitably performed in a non-oxidizing atmosphere or a reducing protective gas atmosphere, at a heat treatment temperature of 650° C. to 850° C. for 5 seconds to 120 seconds. To perform batch annealing of steel sheets, the annealing is suitably performed in a non-oxidizing atmosphere or a reducing protective gas atmosphere at a heat treatment temperature of 400° C. to 700° C. for 20 minutes to 8 hours.

The carbon material coating the plated surface reduces exposure of the nickel-cobalt alloy plating layer, which reduces the elution of cobalt and generation of hydrogen gas.

A highly-conductive oxide film of a nickel-cobalt composite oxide is formed by making the nickel-cobalt alloy plating layer have a thickness of 0.05 μm or more and setting the mass ratio of cobalt relative to the total amount of nickel and cobalt contained in the nickel-cobalt alloy plating layer to be 37% or more. This allows for maintaining suitable electrical contact between the positive electrode case and the positive electrode. Thus, the alkaline dry cell of the present invention has good leak-proof characteristics and provides high discharge performance after storage.

It is preferable that the nickel-cobalt alloy plating layer be intentionally configured to be free from elements which harden the plating and promote the appearance of cracks during the formation of the positive electrode case. Examples of such elements include silver, chromium and boron.

Note that the nickel plating layer (of the nickel-plated steel plate before the formation of the nickel-cobalt alloy plating layer) that functions as the base preferably has a thickness of 2.0 μm or more to reduce elution of iron. It is suitable to limit the thickness to 3.3 μm or less, taking into consideration the manufacturing costs.

The nickel-cobalt alloy plating layer may be formed, for example, by providing electrolytic plating on a face of the nickel-plated steel plate in a mixed solution of nickel sulfate and cobalt sulfate. It is suitable to shape this nickel-plated steel plate by presswork such that the nickel-cobalt alloy plating layer is positioned inside.

The carbon material layer of the present invention is suitably formed by applying, to the inner surface of the positive electrode case, a mixture (coating liquid) prepared by mixing graphite, carbon black and an adhesive with a solvent, and then, by drying the solvent.

Here, it is more preferable that a relational expression, T≦−0.005C+0.575 be satisfied, where T (μm) is the thickness of the nickel-cobalt alloy plating layer, and C (%) is the mass ratio of cobalt relative to the total amount of nickel and cobalt contained in the nickel-cobalt alloy plating layer. This feature further reduces the generation of hydrogen gas.

According to an aspect of the present invention, the positive electrode may contain manganese dioxide which functions as a positive electrode active material, and titanium dioxide. With this configuration, titanium dioxide reacts with the nickel and cobalt of the inner surface of the positive electrode case to produce a nickel-cobalt-titanium composite oxide. This feature may further reduce the elution of cobalt and improve the leak-proof characteristics.

Specifically, it is suitable that the titanium dioxide is contained at a ratio of 1.5% by mass or less relative to the positive electrode. The film of a nickel-cobalt-titanium composite oxide, which is highly conductive, can maintain suitable electrical contact between the positive electrode case and the positive electrode and can further improve the discharge performance after storage.

Quantification of the titanium dioxide contained in a positive electrode from an alkaline dry cell can be performed in the following manner, for example. The positive electrode detached from the cell is washed using distilled water to remove the electrolyte, and then dried. Thereafter, 1.0000 g of the positive electrode is precisely weighed, and mixed with a mixed acid. The resultant mixture is heated and melted at 200° C. for one hour using a hot plate. After separation of the unmelted portion by filtration, ICP-optical emission spectrometry is performed on the mixture using iCAP6300 (product of Thermo Fisher Scientific Inc.), thereby quantifying the titanium contained in the solution. Letting F (% by mass) be the ratio of titanium contained in the detached positive electrode, and based on the formula weight of titanium (47.9) and the formula weight of titanium dioxide (79.9), the quantification is achieved by calculation according to F×(79.9/47.9).

According to an aspect of the present invention, the nickel-cobalt alloy plating layer preferably has a thickness ranging from 0.14 μm to 0.30 μm. This configuration can reduce the amount of burrs which are formed in the manufacturing process of the positive electrode case. Specifically, in the manufacturing process, after forming a nickel steel plate, through presswork, into a cylinder having a bottom, a portion near the opening of the formed cylinder is cut (trimmed) along the outer periphery of the opening, and the burrs are unavoidably formed in this cutting (trimming).

### EXAMPLES

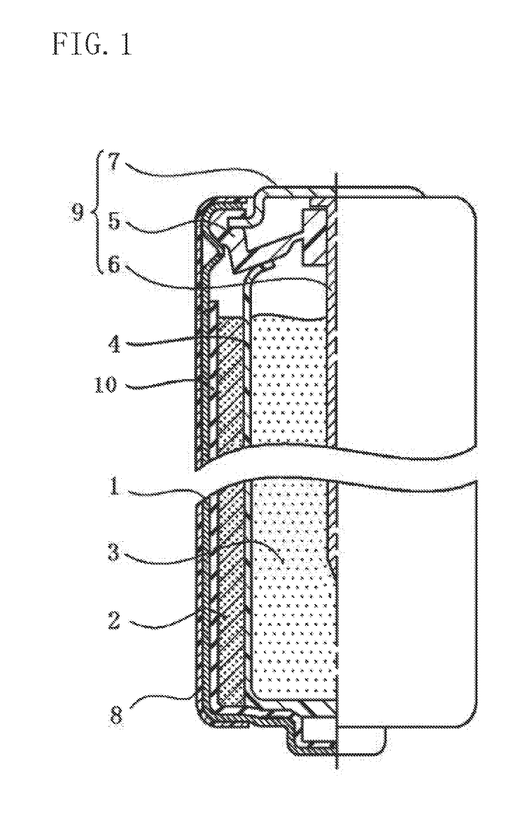

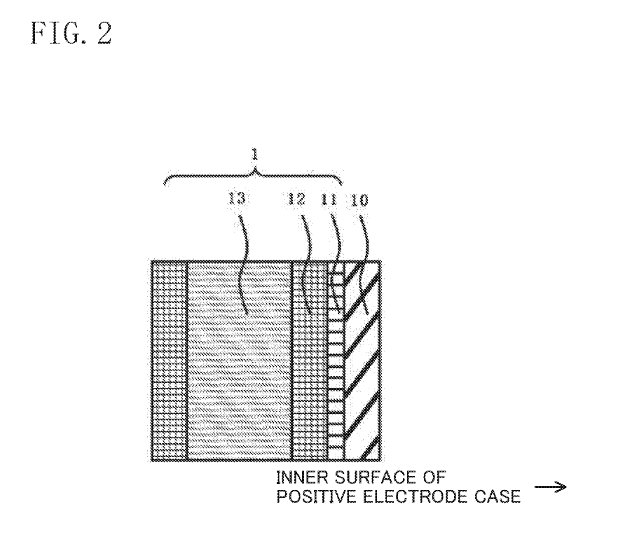

An embodiment of the present invention will be described below in more detail with reference to the drawings. FIG. 1 is a front view of an alkaline dry cell according to the embodiment of the present invention. FIG. 1 also shows the cross section of part of the alkaline dry cell. FIG. 2 shows, in an enlarged scale, a cross section of the positive electrode case of the alkaline dry cell.

Under the conditions described in Table 1 which will be shown later, AA alkaline dry cells (of Examples 1-5 and Comparative Examples 1-3) having the configuration as shown in FIG. 1 were fabricated and evaluated according to the following steps 1-6.

<Step 1> Formation of Positive Electrode Case and Carbon Material Layer on Inner Surface Thereof

A nickel-plated steel sheet including a base material 13 and a nickel plating layer 12 coating the base material 13 and having a thickness of 2.5 μm was placed in a predetermined mixed solution of nickel sulfate and cobalt sulfate, thereby forming a nickel-cobalt alloy plating layer 11 on one face of the steel sheet by electrolytic plating. Thereafter, annealing was performed in such a manner that the steel sheet was placed in a relax oven, and heat treated at 700° C. for 60 minutes in the presence of nitrogen containing 1% hydrogen gas (i.e., in a reducing atmosphere).

Next, the sheet was punched into predetermined circle shapes, and each resultant circular sheet was formed into a cylindrical shape having a bottom and the nickel-cobalt alloy plating layer positioned inside, thereby forming positive electrode cases 1. In this step, the concentrations of nickel sulfate and cobalt sulfate in the mixed solution were adjusted to set the mass ratio of cobalt relative to the total amount of nickel and cobalt of the nickel-cobalt alloy plating layer 11 to each of the values described in Table 1. Further, the thickness of the nickel-cobalt alloy plating layer 11 was set to 0.2 μm by adjusting the coating weight of the electrolytic plating. Note that the cells of Comparative Example 1 were fabricated through the case formation and the subsequent steps, but omitting the annealing.

Graphite, carbon black, polyvinyl butyral (PVB) functioning as an adhesive, and methyl ethyl ketone functioning as a solvent were mixed together, thereby preparing a mixture for carbon material layer. The mixing mass ratio between the graphite, the carbon black, the adhesive and the solvent was set to 18:8:4:70.

The mixture for carbon material layer was applied to the inner surface of each positive electrode case 1, while the positive electrode case 1 was rotated. The mixture was then dried at 200° C. for 30 seconds to evaporate the solvent, thereby forming a carbon material layer 10 on the inner surface of each positive electrode case 1. The applied amount was 0.35 mg/cm².

<Step 2> Preparation of Positive Electrode

Manganese dioxide functioning as a positive electrode active material, graphite, and an alkaline electrolyte were mixed at a mass ratio of 94:6:1.5, and the resultant mixture was compressed and shaped into flakes. The flakes of the mixture for the positive electrode were pulverized into granules, and the granules were classified through a sieve. The granules having a size of 10 mesh to 100 mesh were pressure formed into hollow cylinders, thereby preparing positive electrodes 2. As an alkaline electrolyte, an aqueous solution containing 34.5% by mass of potassium hydroxide and 2.0% by mass of zinc oxide was used.

<Step 3> Assembly of Alkaline Dry Cell

Four pieces of the positive electrodes 2 prepared in the above step were inserted into each positive electrode case 1 formed as described above. The positive electrodes 2 were re-formed with a pressuring jig such that the positive electrodes 2 came into close contact with the carbon material layer 10 on the inner surface of the positive electrode case 1. A separator 4 having a cylindrical shape with a bottom was placed in the center of the positive electrodes 2 arranged in the positive electrode case 1. A predetermined amount of the above alkaline electrolyte was poured into separator 4. After the elapse of a predetermined period, the separator 4 was filled with a negative electrode 3.

As the negative electrode 3, a mixture containing sodium polyacrylate functioning as a gelatinizer, an alkaline electrolyte, and a zinc alloy powder functioning as a negative electrode active material at a mass ratio of 1:35:64 was used.

The alkaline electrolyte was an aqueous solution containing 34.5% by mass of potassium hydroxide and 2.0% by mass of zinc oxide.

The zinc alloy powder contained Al, Bi and In at concentrations of 30 ppm, 100 ppm and 200 ppm, respectively.

The separator 4 was made of unwoven fabric containing, as its main materials, polyvinyl alcohol fibers and rayon fibers mixed therein.

Next, a negative electrode current collector 6 was inserted in the center of the negative electrode 3. A gasket 5 made of 66 nylon and a bottom plate 7 functioning also as a negative electrode terminal were provided to be integral with the negative electrode current collector 6 such that these components together formed a sealing unit 9. The rim of the opening of each positive electrode case 1 was caulked on a peripheral portion of the bottom plate 7 with the end of the gasket 5 interposed therebetween, thereby sealing the opening of the positive electrode case 1. Lastly, the outer surface of the positive electrode case 1 was coated with an exterior label 8. In this manner, each of the alkaline dry cells was fabricated.

<Step 4> Evaluation of Leak-proof Characteristics of Alkaline Dry Cells

Hundred alkaline dry cells fabricated in the above manner were stored at 80° C. for three months. After the storage, cells in which leakage was observed were counted.

<Step 5> Evaluation of Amounts of Gas Generated in Alkaline Dry Cells Hundred alkaline dry cells fabricated in the above manner were stored at 80° C. for two weeks. These cells were used for evaluation of amounts of generated gas. Specifically, each alkaline dry cell stored under the above conditions was disassembled under water, and gas generated in the cell was collected and measured in a graduated cylinder by water displacement method. The measurement of the amounts of generated gas was conducted at 20±2° C. Letting E (ml) be the amount of gas collected after the storage and letting F (ml) be the amount of gas collected before storage, the amount of the generated gas was calculated by subtracting F from E. Note that an amount of generated gas smaller than 0.1 ml is below the measuring limit.

<Step 6> Evaluation of Discharge Performance of Alkaline Dry Cells after Storage

The alkaline dry cells fabricated in the above manner were stored at 60° C. for five weeks. These cells were used for evaluation of discharge performance. This storage condition is considered to be equivalent to storage of ten years at room temperatures.

Each alkaline dry cell that had been stored under the above condition was made to continuously discharge at 1000 mA, and the duration of the discharge until the closed circuit voltage reached 0.9 V was measured. The discharge was carried out 20±2° C.

The fabrication conditions and the evaluation results of the cells of Examples 1-5 and Comparative Examples 1-3 are shown in Table 1.

TABLE 1

| | Nickel-cobalt Alloy | | | | | |
|---|---|---|---|---|---|---|
| | Plating Layer | | | The number of | The amount [ml] | The discharge |
| | Thick- | Cobalt | | cells having leakage | of generated gas | performance [min] |
| | ness | (% by | Anneal- | after storage | after storage | after storage |
| | (μm) | mass) | ing | (80° C., 3 months) | (80° C., 2 weeks) | (60° C., 5 weeks) |
| Comparative Ex 1 | 0.2 | 50 | Omitted | 9 | 0.8 | 53.3 |
| Comparative Ex 2 | | 67 | Done | 2 | 0.3 | 53.5 |
| Example 1 | | 57 | Done | 0 | 0.1 | 53.4 |
| Example 2 | | 52 | Done | 0 | Below measuring limit | 53.3 |
| Example 3 | | 47 | Done | 0 | Below measuring limit | 53.3 |
| Example 4 | | 42 | Done | 0 | Below measuring limit | 53.2 |
| Example 5 | | 37 | Done | 0 | Below measuring limit | 53.3 |
| Comparative Ex 3 | | 32 | Done | 0 | Below measuring limit | 49.6 |

The results revealed that the cells in which the mass ratio of cobalt relative to the total amount of nickel and cobalt contained in the nickel-cobalt alloy plating layer is 57% by mass or less (i.e., Examples 1-5) have good leak-proof characteristics. With a mass ratio of cobalt of 52% by mass or less, almost no influence of the elution of cobalt was observed as far as the amount of generated gas is concerned.

This would be because a mass ratio of cobalt of 57% by mass or less would hinder the cobalt from hardening the nickel-cobalt alloy plating layer, and would reduce appearance of cracks in the plated surface during the formation of the positive electrode case. Also, the carbon material layer coating the plated surface would reduce the elution of cobalt.

Further, the results revealed that the cells having a mass ratio of cobalt of 37% by mass or more have good discharge performance after five weeks of storage at 60° C. This would be because the highly-conductive oxide film made of a nickel-cobalt composite oxide and coating the inner surface of the positive electrode case would maintain good electrical contact between the positive electrode case and the positive electrode.

On the other hand, the result of Comparative Example 1 shows that the omission of the annealing leads to a significant increase in the amount of generated gas and deterioration of the leak-proof characteristics, even with a mass ratio of cobalt of 50%. This would be because an increase in the mass ratio of cobalt caused due to the omission of the annealing would harden the plated surface and increase internal distortion. The distortion would be released when the positive electrode case was formed, which would promote appearance of cracks in the plated surface. The positive electrode case in such a state would have an increased surface area and cracked portions not covered with the oxide film. The positive electrode case would be oxidized by the highly-oxidative positive electrode active material, and the elution of cobalt would be promoted. The eluted cobalt would be reduced and deposited on the negative electrode and promote corrosion of zinc. Consequently, hydrogen gas would be generated to increase the internal pressure of the cell, thereby causing the leakage.

The result of Comparative Example 2 shows that a mass ratio of cobalt of 67% leads to a significant increase in the amount of generated gas and a deterioration of the leak-proof characteristics, in spite of the annealing. This would be because an increase in the mass ratio of cobalt would harden the plated surface and would promote appearance of cracks in the plated surface during the formation of the positive electrode case, thereby causing the leakage.

Further, the result of Comparative Example 3 shows that a mass ratio of cobalt of 32% leads to a deterioration of the discharge performance after storage. This would be because an oxide film having a low conductivity and formed on the inner surface of the positive electrode case would degrade the electrical contact between the positive electrode case and the positive electrode.

Next, variation in the thickness of the nickel-cobalt alloy plating layer was evaluated. Alkaline dry cells of Examples 6-10, Comparative Examples 4 and 5 were configured to have a mass ratio of cobalt of 47% relative to the total amount of nickel and cobalt contained in the nickel-cobalt alloy plating layer. These cells were fabricated in the same manner as the cells of Example 3, except that their nickel-cobalt alloy plating layers had different thicknesses as shown in Table 2. Table 2 also shows the evaluation results of these cells.

TABLE 2

| | Nickel-cobalt Alloy | | | | | |
|---|---|---|---|---|---|---|
| | Plating Layer | | | The number of | The amount [ml] | The discharge |
| | Thick- | Cobalt | | cells having leakage | of generated gas | performance [min] |
| | ness | (% by | Anneal- | after storage | after storage | after storage |
| | (μm) | mass) | ing | (80° C., 3 months) | (80° C., 2 weeks) | (60° C., 5 weeks) |
| Comparative Ex 4 | 0.02 | 47 | Done | 0 | Below measuring limit | 49.8 |
| Example 6 | 0.05 | | | 0 | Below measuring limit | 53.2 |
| Example 7 | 0.1 | | | 0 | Below measuring limit | 53.4 |
| Example 3 | 0.2 | | | 0 | Below measuring limit | 53.3 |
| Example 8 | 0.3 | | | 0 | Below measuring limit | 53.2 |
| Example 9 | 0.35 | | | 0 | Below measuring limit | 53.3 |
| Example 10 | 0.4 | | | 0 | 0.2 | 53.4 |
| Comparative Ex 5 | 0.5 | | | 4 | 0.7 | 53.4 |

The results shown in Table 2 revealed that the cells including the nickel-cobalt alloy plating layer having a thickness of 0.4 μm or less (i.e., Examples 3 and 6-10) have good leak-proof characteristics. This would be because the nickel-cobalt alloy plating layer having a reduced thickness would receive reduced direct damage caused during the formation of the positive electrode case, and the appearance of cracks in the plated surface during the formation of the positive electrode case would be consequently reduced.

The result of Comparative Example 5 shows that the thickness of the nickel-cobalt alloy plating layer greater than 0.5 μm leads to a significant increase in the amount of generated gas and a deterioration of the leak-proof characteristics. This would be because such an increase in the thickness of the nickel-cobalt alloy plating layer would hinder the nickel-cobalt alloy plating layer from following the nickel-cobalt steel plate, and the nickel-cobalt alloy plating layer would directly receive the physical damage caused during the formation of the positive electrode case, thereby promoting the appearance of cracks in the plated surface during the formation of the positive electrode case.

The results shown in Table 2 revealed that the cells in which the nickel-cobalt alloy plating layer has a thickness of 0.05 μm or more have high discharge performance after five weeks of storage at 60° C. This would be because the highly-conductive oxide film made of a nickel-cobalt composite oxide and coating the inner surface of the positive electrode case would maintain good electrical contact between the positive electrode case and the positive electrode.

The result of Comparative Example 4 shows that the nickel-cobalt alloy plating layer having a thickness of 0.02 μm causes a deterioration of the discharge performance after storage. This would be because the highly-conductive oxide film made of a nickel-cobalt composite oxide would insufficiently coat the nickel plating layer, which would degrade the electrical contact between the positive electrode case and the positive electrode.

In the examples listed in Tables 1 and 2, the thickness of the nickel-cobalt alloy plating layer and the mass ratio of cobalt relative to the total amount of nickel and cobalt were evaluated separately. Next, combinations of the thickness and the mass ratio were evaluated.

Cells of Examples 11-40 were fabricated in the same manner as the cells of the other examples, except that the thickness of the nickel-cobalt alloy plating layer and the mass ratio of cobalt relative to the total amount of nickel and cobalt were varied as shown in Table 3. Table 3 also shows the evaluation results of the cells.

TABLE 3

| | Nickel-cobalt Alloy | | | | | |
|---|---|---|---|---|---|---|
| | Plating Layer | | | The number of | The amount [ml] | The discharge |
| | Thick- | Cobalt | | cells having leakage | of generated gas | performance [min] |
| | ness | (% by | Anneal- | after storage | after storage | after storage |
| | (μm) | mass) | ing | (80° C., 3 months) | (80° C., 2 weeks) | (60° C., 5 weeks) |
| Example 11 | 0.05 | 57 | Done | 0 | Below measuring limit | 53.3 |
| Example 12 | | 52 | | 0 | Below measuring limit | 53.2 |
| Example 6 | | 47 | | 0 | Below measuring limit | 53.2 |
| Example 13 | | 42 | | 0 | Below measuring limit | 53.2 |
| Example 14 | | 37 | | 0 | Below measuring limit | 53.2 |
| Example 15 | 0.1 | 57 | | 0 | Below measuring limit | 53.3 |
| Example 16 | | 52 | | 0 | Below measuring limit | 53.4 |
| Example 7 | | 47 | | 0 | Below measuring limit | 53.4 |
| Example 17 | | 42 | | 0 | Below measuring limit | 53.3 |
| Example 18 | | 37 | | 0 | Below measuring limit | 53.3 |
| Example 19 | 0.14 | 57 | | 0 | Below measuring limit | 53.3 |
| Example 20 | | 52 | | 0 | Below measuring limit | 53.4 |
| Example 21 | | 47 | | 0 | Below measuring limit | 53.3 |
| Example 22 | | 42 | | 0 | Below measuring limit | 53.2 |
| Example 23 | | 37 | | 0 | Below measuring limit | 53.3 |
| Example 1 | 0.2 | 57 | | 0 | Below measuring limit | 53.4 |
| Example 2 | | 52 | | 0 | Below measuring limit | 53.3 |
| Example 3 | | 47 | | 0 | Below measuring limit | 53.3 |
| Example 4 | | 42 | | 0 | Below measuring limit | 53.2 |
| Example 5 | | 37 | | 0 | Below measuring limit | 53.3 |
| Example 24 | 0.26 | 57 | | 0 | Below measuring limit | 53.4 |
| Example 25 | | 52 | | 0 | Below measuring limit | 53.2 |
| Example 26 | | 47 | | 0 | Below measuring limit | 53.2 |
| Example 27 | | 42 | | 0 | Below measuring limit | 53.3 |
| Example 28 | | 37 | | 0 | Below measuring limit | 53.2 |
| Example 29 | 0.3 | 57 | | 0 | Below measuring limit | 53.4 |
| Example 30 | | 52 | | 0 | Below measuring limit | 53.2 |
| Example 8 | | 47 | | 0 | Below measuring limit | 53.2 |
| Example 31 | | 42 | | 0 | Below measuring limit | 53.4 |
| Example 32 | | 37 | | 0 | Below measuring limit | 53.3 |
| Example 33 | 0.35 | 57 | | 0 | 0.2 | 53.2 |
| Example 34 | | 52 | | 0 | 0.2 | 53.2 |
| Example 9 | | 47 | | 0 | Below measuring limit | 53.3 |
| Example 35 | | 42 | | 0 | Below measuring limit | 53.4 |
| Example 36 | | 37 | | 0 | Below measuring limit | 53.3 |
| Example 37 | 0.4 | 57 | | 0 | 0.3 | 53.4 |
| Example 38 | | 52 | | 0 | 0.3 | 53.3 |
| Example 10 | | 47 | | 0 | 0.2 | 53.4 |
| Example 39 | | 42 | | 0 | 0.2 | 53.2 |
| Example 40 | | 37 | | 0 | Below measuring limit | 53.3 |

The result shown in Table 3 revealed that the cells of which the thickness of the nickel-cobalt alloy plating layer is in the range from 0.05 μm to 0.4 μm and the mass ratio of cobalt relative to the total amount of nickel and cobalt of the nickel-cobalt alloy plating layer is in the range from 37% to 57% have good leak-proof characteristics and provide high discharge performance after storage.

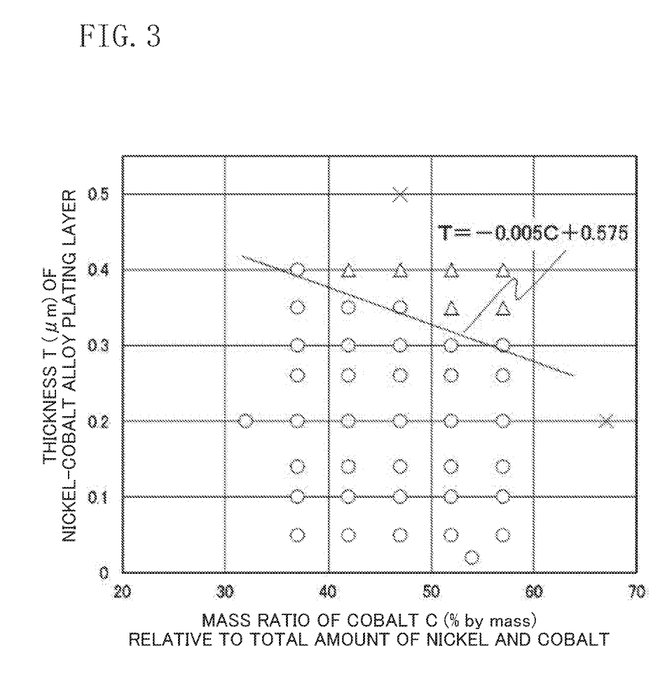

Reference is now made to the amounts of generated gas. It was noted that the amounts of generated gas of the cells, in which no leakage occurred, differed from cell to cell. In view of this, for Comparative Examples 2-5 and Examples 1-40, the amounts of generated gas measured after two weeks of storage at 80° C. are plotted, with marks as described below, on the graph of FIG. 3. In FIG. 3, the vertical axis represents the thickness T (μm) of the nickel-cobalt alloy plating layer, and the horizontal axis represents the mass ratio of cobalt C (%) relative to the total amount of nickel and cobalt.

<Meaning of Plot Marks>

The circle mark represents a case where the amount of generated gas measured after two weeks of storage at 80° C. was below the measuring limit.

The triangle mark represents a case where a significant amount of gas was generated, but no leakage occurred.

The cross mark represents a case where leakage occurred.

As shown in FIG. 3, there is a region in which the amount of generated gas measured after two weeks of storage at 80° C. is below the measuring limit (as indicated by the circle marks), that is, almost no influence of the elution of cobalt is observed. It was revealed that in the region, the thickness T (μm) of the nickel-cobalt alloy plating layer has correlation to the mass ratio of cobalt C (%).

Focusing on the boundary between the area where the circle marks are present and the area where the triangle marks are present, a linear regression analysis was conducted on five points (C, T) indicated by the circle marks, specifically, the points of (37, 0.4), (42, 0.35), (47, 0.35), (52, 0.3) and (57, 0.3). As a result, the following highly correlative equation of a line was given from the five points: T=−0.005C+0.575.

That is to say, if the condition expressed by the relational expression, T≦−0.005C+0.575 is met, a significant reduction of the generation of hydrogen gas and better leak-proof characteristics are achievable.

Next, a variant of the present invention is described. For further reduction of the amount of gas generated after storage, addition of titanium dioxide to the positive electrode 2 was evaluated. The added titanium dioxide was of anatase type. Alkaline dry cells were fabricated in the same manner as in Example 37, except that the anatase titanium dioxide was added at various ratios (% by mass) shown in Table 4. The table 4 also shows the evaluation results of these alkaline dry cells.

TABLE 4

| | Nickel-cobalt Alloy | | | Ratio [% by | | | |
|---|---|---|---|---|---|---|---|
| | Plating Layer | | | mass] of Added | The number of | The amount [ml] | The discharge |
| | Thick- | Cobalt | | TiO₂ relative | cells having leakage | of generated gas | performance [min] |
| | ness | (% by | Anneal- | to Positive | after storage | after storage | after storage |
| | (μm) | mass) | ing | Electrode | (80° C., 3 months) | (80° C., 2 weeks) | (60° C., 5 weeks) |
| Example 37 | 0.4 | 57 | Done | 0 | 0 | 0.3 | 53.4 |
| Example 41 | | | | 0.1 | 0 | 0.2 | 54.1 |
| Example 42 | | | | 0.5 | 0 | Below measuring limit | 54.9 |
| Example 43 | | | | 1.0 | 0 | Below measuring limit | 55.0 |
| Example 44 | | | | 1.5 | 0 | Below measuring limit | 54.9 |
| Example 45 | | | | 2.0 | 0 | Below measuring limit | 53.8 |

The results of Examples 41-45 revealed that addition of titanium dioxide to the positive electrode 2 reduces the amount of gas generated after storage. This would be because the added titanium dioxide would react with nickel and cobalt of the inner surface of the positive electrode case 1 to produce a nickel-cobalt-titanium composite oxide, which would further reduce the elution of cobalt.

This composite oxide film is highly conductive and capable of maintaining suitable electrical contact between the positive electrode case 1 and the positive electrode 2. As a result, the discharge performance after storage is improved further.

However, excessive addition of titanium dioxide to the positive electrode 2 leads to a deterioration of the discharge performance caused by a relative decrease of the amount of the positive electrode active material. It is therefore preferable to limit the ratio of titanium dioxide added to the positive electrode 2 to 1.5% by mass or less.

Next, another advantageous aspect of the present invention will be described below. The positive electrode case 1 is formed in the following manner: a nickel steel plate is formed, through presswork, into a cylinder having a bottom, and a portion near the opening of the formed cylinder is cut (trimmed) along the outer periphery of the opening. This cutting of the formed cylinder is carried out by presswork using a punch and a die engaged with each other. In this type of presswork, however, a gap (clearance) is provided between the punch and the die, and the gap unavoidably leaves burrs on the cut surface.

If a cell is fabricated using a positive electrode case 1 having burrs remaining on its opening, the following problems may be caused. In a situation where burrs are on the outer side of the positive electrode case 1, through the caulking of the opening of the positive electrode case 1, the cell will enter a short circuit state (outer short circuit) and will be exhausted. Specifically, when the sealing unit 9 with which the bottom plate 7 that also functions as the negative electrode terminal is integrated is placed on the opening of the positive electrode case 1 and the opening is caulked, the end surface of the positive electrode 1 and the bottom plate 7 are brought into electrical contact with each other via the burrs. On the other hand, in a situation where burrs are on the inner side of the positive electrode case 1, the burrs as impurities enter the inside of the negative electrode 3, which generates gas and consequential leakage.

The inventor of the present invention also noticed, through the evaluation of the results shown in Tables 1-5, that the state in which the burrs were formed varied depending on the types of the nickel-cobalt alloy plating. Accordingly, the amounts of formed burrs were evaluated, not only under the various plating conditions shown in Table 3, but also under the condition in which a nickel-cobalt alloy plating layer is formed and annealing is omitted (i.e., Comparative Example 1), and the condition in which no nickel-cobalt alloy plating layer is formed while a nickel plating layer having a thickness of 2.5 μm is formed (i.e., Comparative Examples 5 and 6 where annealing was omitted or done).

For each condition, 10,000 positive electrode cases were cut (trimmed) with a punch equivalent to a cutting blade, and metal pieces accumulating on the punch were assumed to be the formed burrs and collected for measurement. The weights of the collected burrs were measured by using an electronic force balance capable of indicating 0.001 g (1 mg) as the minimum value. The measurement results are shown in Table 5.

TABLE 5

| | Nickel-cobalt Alloy | | | Amount of |
|---|---|---|---|---|
| | Plating Layer | | | Formed |
| | Thick- | Cobalt | | Burrs |
| | ness | (% by | Anneal- | [mg/10000 |
| | (μm) | mass) | ing | cases] |
| Comparative Ex 1 | 0.2 | 50 | Omitted | 10 |
| Comparative Ex 5 | Without Nickel-cobalt | | Omitted | 8 |
| Comparative Ex 6 | Alloy Plating Layer | | Done | 9 |
| Example 11 | 0.05 | 57 | Done | 3 |
| Example 12 | | 52 | | 4 |
| Example 6 | | 47 | | 4 |
| Example 13 | | 42 | | 5 |
| Example 14 | | 37 | | 6 |
| Example 15 | 0.1 | 57 | | 2 |
| Example 16 | | 52 | | 2 |
| Example 7 | | 47 | | 2 |
| Example 17 | | 42 | | 3 |
| Example 18 | | 37 | | 4 |
| Example 19 | 0.14 | 57 | | —* |
| Example 20 | | 52 | | —* |
| Example 21 | | 47 | | —* |
| Example 22 | | 42 | | —* |
| Example 23 | | 37 | | —* |
| Example 1 | 0.2 | 57 | | —* |
| Example 2 | | 52 | | —* |
| Example 3 | | 47 | | —* |
| Example 4 | | 42 | | —* |
| Example 5 | | 37 | | —* |
| Example 24 | 0.26 | 57 | Done | —* |
| Example 25 | | 52 | | —* |
| Example 26 | | 47 | | —* |
| Example 27 | | 42 | | —* |
| Example 28 | | 37 | | —* |
| Example 29 | 0.3 | 57 | | —* |
| Example 30 | | 52 | | —* |
| Example 8 | | 47 | | —* |
| Example 31 | | 42 | | —* |
| Example 32 | | 37 | | —* |
| Example 33 | 0.35 | 57 | | 1 |
| Example 34 | | 52 | | 2 |
| Example 9 | | 47 | | 2 |
| Example 35 | | 42 | | 2 |
| Example 36 | | 37 | | 3 |
| Example 37 | 0.4 | 57 | | 2 |
| Example 38 | | 52 | | 3 |
| Example 10 | | 47 | | 3 |
| Example 39 | | 42 | | 4 |
| Example 40 | | 37 | | 4 |

*The mark “—” means a value below the measuring limit

The results shown in Table 5 indicate that under the condition where no nickel-cobalt alloy plating layer is formed (Comparative Examples 5 and 6), the annealing does not reduce the amount of formed burrs. On the other hand, under the condition where the nickel-cobalt alloy plating layer is formed and the annealing is omitted (Comparative Example 1), the amount of formed burrs increased slightly. In contrast, in all of the cells fabricated under the condition where the nickel-cobalt alloy plating layer is formed and the annealing is done, the reduction of the amounts of formed burrs is achievable.

This would be because, in the case of the nickel plating, burrs would be easily formed since the plating film would easily extend to follow the punch during the cutting. On the other hand, the annealing makes the nickel-cobalt alloy plating layer highly crystalline and resistant to recrystallization that results in a granular structure, which can prevent the plating film from following the punch.

Further, in the cases where the nickel-cobalt alloy plating layer has a thickness ranging from 0.14 μm to 0.30 μm (Examples 1-5, 8, 9 and 19-32), the amounts of formed burrs are so small that the electronic force balance used for the evaluation cannot measure.

That is to say, forming a nickel-cobalt alloy plating layer having a thickness ranging from 0.14 μm to 0.30 μm and annealing the nickel-cobalt alloy plating layer can effectively reduce the occurrence of outer short circuit in the cell manufacturing process and lower the risk of leakage which could be caused by the entry of impurity.

### INDUSTRIAL APPLICABILITY

As can be seen from the foregoing, the alkaline dry cell of the present invention has good leak-proof characteristics and high discharge performance after storage, and is suitably used as an emergency power source in case of a natural disaster, for example.

### DESCRIPTION OF REFERENCE CHARACTERS

1 Positive Electrode Case
2 Positive Electrode
3 Negative Electrode
4 Separator
5 Gasket
6 Negative Electrode Current Collector
7 Bottom Plate
8 Exterior Label
9 Sealing Unit
10 Carbon Material Layer
11 Nickel-cobalt Alloy Plating Layer
12 Nickel Plating Layer
13 Base Material

1. An alkaline dry cell comprising:
a positive electrode case made of a nickel-plated steel plate having a nickel plating layer on a surface thereof;
a positive electrode having a hollow cylindrical shape and provided in the positive electrode case; and
a negative electrode provided in a hollow portion of the positive electrode with a separator interposed between the positive and negative electrodes, wherein
the positive electrode case has a nickel-cobalt alloy plating layer and a carbon material layer which extend over the nickel plating layer on an inner surface of the positive electrode case,
the carbon material layer is formed after annealing of the nickel-cobalt alloy plating layer formed on the nickel plating layer,
the nickel-cobalt alloy plating layer has a thickness ranging from 0.05 μm to 0.4 μm, and
a mass ratio of cobalt relative to a total amount of nickel and cobalt contained in the nickel-cobalt alloy plating layer ranges from 37% to 57%.

2. The alkaline dry cell of claim 1, wherein
a relational expression, T≦−0.005C+0.575 is satisfied, where T (μm) is the thickness of the nickel-cobalt alloy plating layer, and C (%) is the mass ratio of cobalt relative to the total amount of nickel and cobalt contained in the nickel-cobalt alloy plating layer.

3. The alkaline dry cell of claim 1, wherein
the positive electrode contains manganese dioxide which functions as a positive electrode active material, and titanium dioxide.

4. The alkaline dry cell of claim 3, wherein
the titanium dioxide is contained at a ratio of 1.5% by mass or less relative to the positive electrode.

5. The alkaline dry cell of claim 1, wherein
the nickel-cobalt alloy plating layer has a thickness ranging from 0.14 μm to 0.30 μm.

6. A method for manufacturing a positive electrode case for use in the alkaline dry cell of claim 1, the method comprising:
providing a nickel-plated steel plate having a nickel plating layer on a surface thereof;
annealing, after formation of a nickel-cobalt alloy plating layer on the nickel plating layer, the nickel-cobalt alloy plating layer;
shaping the nickel-plated steel plate into the positive electrode case having a cylindrical shape with a bottom such that the nickel-cobalt alloy plating layer is positioned on an inner surface of the positive electrode case, and
forming a carbon material layer on the nickel-cobalt alloy plating layer on the inner surface of the positive electrode case.

7. The method of claim 6, wherein
the carbon material layer is formed by applying a coating liquid containing a carbon material over the inner surface of the positive electrode case while the positive electrode case is rotated, and by drying the applied liquid.
